(19) United States
(12) Patent Application Publication
(10) Pub. No.: US 2016/0175972 A1
(43) Pub. Date: Jun. 23, 2016

(54) SYSTEMS AND METHODS FOR PROVIDING A WELDING SYSTEM ACCESS TO A NETWORK VIA POWER LINES

(71) Applicant: ILLINOIS TOOL WORKS INC., Glenview, IL (US)

(72) Inventor: Marc Lee Denis, Lena, WI (US)

(21) Appl. No.: 14/575,825

(22) Filed: Dec. 18, 2014

(51) Int. Cl. B23K 9/10; H04B 3/54

(52) U.S. Cl. CPC B23K 9/1087; H04B 3/542

(57) ABSTRACT

A welding power supply unit may include a communication circuit that receives a first set of data via a power cable configured to provide power to the welding power supply unit for use in a welding operation. The communication circuit may then convert the first set of data into a second set of data configured to be interpretable by a network device and send the second set of data to the network device.

### BACKGROUND

The present disclosure relates generally to welding systems. More specifically, the present disclosure is related to transmitting data from a welding system to a network.

Welding is a process that has become increasingly prevalent in various industries and applications. Such processes may be automated in certain contexts, although a large number of applications continue to exist for manual welding applications. In both cases, such welding applications rely on a variety of types of equipment to ensure that the supply of welding consumables (e.g., wire, shielding gas) is provided to the weld in an appropriate amount at the desired time. For example, a metal inert gas (MIG) welding system typically relies on a wire feeder to enable a welding wire to reach a welding torch. The wire is continuously fed during welding to provide filler metal. The MIG welding system may also include a welding power source that ensures that arc heating is available to melt the filler metal and the underlying base metal. In certain applications, the welding system may include power cables that supply power from the welding power source to a welding torch performing a welding application. For example, the welding power source may provide a welding voltage that may be utilized between the welding torch and a workpiece to perform the welding application.

To further enhance the operability of traditional welding systems, data regarding the welding systems may be analyzed and shared with, for example, other welding systems as well as various data analysis services. However, due to the environments in which welding systems may be employed, it may be difficult to communicate data regarding the welding system to other entities.

### BRIEF DESCRIPTION

Certain embodiments in accordance with present disclosure are summarized below. These embodiments are not intended to limit the scope of the present disclosure, but rather these embodiments are intended only to provide a brief summary of possible forms of the present disclosure. Indeed, the present disclosure may encompass a variety of forms that may be similar to or different from the embodiments set forth below.

In one embodiment, a welding power supply unit may include a communication circuit that receives a first set of data via a power cable configured to provide power to the welding power supply unit for use in a welding operation. The communication circuit may then convert the first set of data into a second set of data configured to be interpretable by a network device and send the second set of data to the network device.

In another embodiment, a welding system may include one or more power cables that provide an alternating current (AC) power from a source of power to a plurality of welding power supply units. The welding system may also include a first welding power supply unit of the plurality of welding power supply units that receives the AC power via one of the power cables. The first welding power supply unit may include a first communication component that couples to the one of the power cables, such that the first communication component sends a first set of data via the one of the power cables. The welding system may also include a second welding power supply unit that receives the AC power via the one of the power cables, such that the second welding power supply unit may include a second communication component that couples to the one of the power cables. The second communication component may then receive the first set of data via the one of the power cables.

In yet another embodiment, a device that communicates data via an alternating current (AC) power line may include a processor that receives a first set of data from a welding power supply unit that performs a welding operation. The processor may then convert the first set of data to a second set of data that may be transmitted via the power line configured to provide power to the welding supply unit. The processor may then send the second set of data to a communication circuit of a second welding power supply unit via the power line or to a network device.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example welding system having a communication system as part of a welding power source, in accordance with embodiments described herein;

FIG. 2 illustrates a block diagram of components that may be part of the communication system of FIG. 1, in accordance with embodiments described herein;

FIG. 3 illustrates a block diagram of a network that facilitates communication between welding systems and a cloud-based computing system, in accordance with embodiments described herein;

FIG. 4 illustrates a block diagram of functional components that may be part of the cloud-based computing system of FIG. 2, in accordance with embodiments described herein;

FIG. 5 illustrates a flow chart of a method for transmitting data from a welding system via a power line, in accordance with embodiments described herein; and

FIG. 6 illustrates a flow chart of a method for transmitting data received via a power line to a network, in accordance with embodiments described herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present disclosure are generally directed towards enabling components in a welding system to communicate with a network. More specifically, embodiments of the present disclosure are related to providing a digital communication network for components within a welding system to communicate with each other via power lines. Generally, multiple welding power supplies may receive alternating current (AC) power via an AC power source and AC power lines. In certain embodiments, each welding power supply may include a communication system that receives data from various components within a respective welding system. Upon receiving the data, the communication system may transmit the data to another communication system that may be part of another welding power supply via power lines. That is, when two welding power supplies receive AC power from the same AC power source, the power lines between the two welding power supplies and the AC power source may facilitate data transfers between the two welding power supplies. After receiving data via the AC power lines, one of the communication systems described above that may be communicatively coupled to a network may transmit the received data to a cloud-computing system or the like. In this manner, data acquired from multiple welding systems may communicate with each other via a local network established using the AC power lines. In addition, each of the inter-communicating welding systems may also transmit data and receive data to and from a cloud-based computing system or some other network using the existing network connection of a welding system.

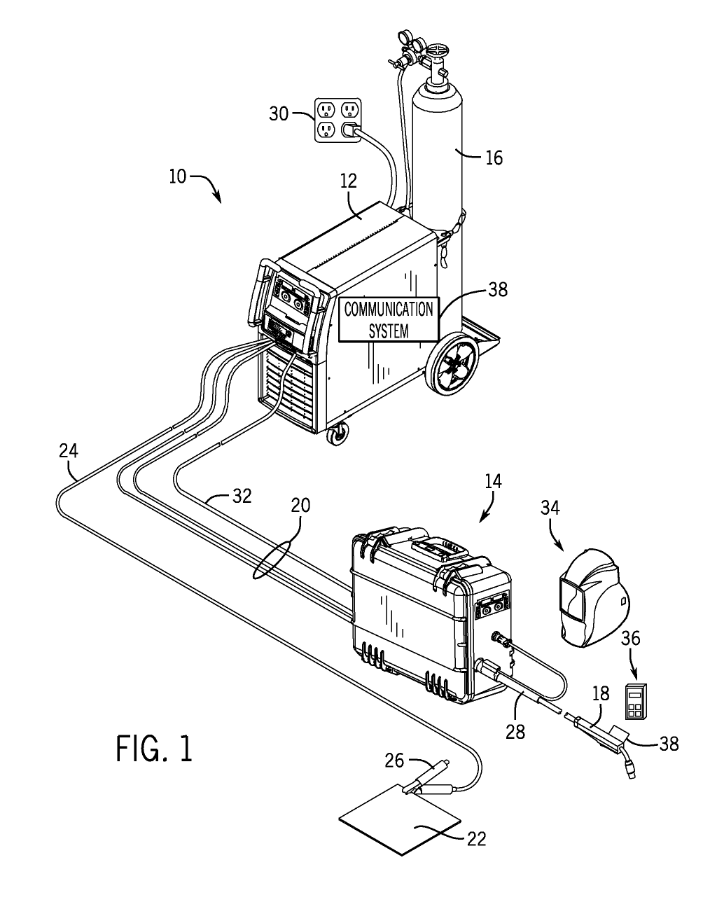

By way of introduction, FIG. 1 illustrates an example weld system 10 that uses a communication system to communicate via power lines. It should be appreciated that, while the welding system 10 described herein is specifically presented as a gas metal arc welding (GMAW) system 10, the presently disclosed system may also be used with other arc welding processes (e.g., FCAW, FCAW-G, GTAW, SAW, SMAW, or similar arc welding processes) or other metal fabrication systems, such as plasma cutting systems, induction heating systems, and so forth. The welding system 10 includes a welding power supply unit 12 (i.e., a welding power source), a welding wire feeder 14, a gas supply system 16, and a welding torch 18. The welding power supply unit 12 generally supplies power for the welding system 10 and other various accessories, and may be coupled to the welding wire feeder 14 via a weld cable 20 as well as coupled to a workpiece 22 using a return path via a work cable 24 having a clamp 26. In the illustrated embodiment, the welding wire feeder 14 is coupled to the welding torch 18 via a weld cable 28 in order to supply welding wire and power to the welding torch 18 during operation of the welding system 10. In another embodiment, the welding power supply unit 12 may couple with and directly supply power to the welding torch 18.

Before proceeding, it should be noted that the welding equipment and accessories illustrated in FIG. 1 are merely exemplary. That is, it should be understood that the components presented in the welding system 10 of FIG. 1 are not intended to be limiting of the types of welding equipment and accessories that may be used in the welding system 10.

Referring again to FIG. 1, the welding power supply unit 12 may generally include power conversion circuitry that receives input power from an alternating current power source 30 (e.g., an engine/generator set, or a combination thereof), conditions the input power, and provides DC or AC output power via the weld cable 20. The AC power source 30 may be single or multi-phase power source and may or may not have transformers between the connected supplies. In any case, the welding power supply unit 12 may receive power from the AC power source 30 to provide power to the welding wire feeder 14 that, in turn, powers the welding torch 18, in accordance with demands of the welding system 10. The work cable 24 terminating in the clamp 26 couples the welding power supply unit 12 to the workpiece 22 to close the circuit between the welding power supply unit 12, the workpiece 22, and the welding torch 18. The welding power supply unit 12 may include circuit elements (e.g., transformers, rectifiers, switches) capable of converting the AC input power to a direct current electrode positive (DCEP) output, direct current electrode negative (DCEN) output, DC variable polarity, or a variable balance (e.g., balanced or unbalanced) AC output, as dictated by the demands of the welding system 10 (e.g., based on the type of welding process performed by the welding system 10, and so forth).

The illustrated welding system 10 includes a gas supply system 16 that supplies a shielding gas or shielding gas mixtures to the welding torch 18. In the depicted embodiment, the gas supply system 16 is directly coupled to the welding torch 18 via a gas conduit 32 from the welding power supply unit 12. In another embodiment, the gas supply system 16 may instead be coupled to the welding wire feeder 14, and the welding wire feeder 14 may regulate the flow of gas from the gas supply system 16 to the welding torch 18. A shielding gas, as used herein, may refer to any gas or mixture of gases that may be provided to the arc and/or weld pool in order to provide a particular local atmosphere (e.g., shield the arc, improve arc stability, limit the formation of metal oxides, improve wetting of the metal surfaces, alter the chemistry of the weld deposit, and so forth).

In addition, in certain embodiments, other welding equipment and welding accessories (e.g., welding-related devices) may be used in the welding system 10. For example, in most welding applications, a welding helmet 34 may be worn by an operator of the welding system 10. The welding helmet 34 provides protection to the operator of the welding system 10, particularly protecting the eyes of the operator from the flashing associated with the welding arc during welding operations. In addition, in certain embodiments, the welding helmet 34 may provide feedback to the operator related to parameters of the welding operations. For example, the welding helmet 34 may include an internal display configured to display the welding parameters to the operator during the welding operations. In addition, in certain embodiments, a welding accessory 36 (also referred to as a welding subsystem) may be used to communicate between the welding wire feeder 14 and the welding torch 18. For example, the welding accessory 36 may be a pendant, a sensor, a battery, or the like. In certain embodiments, the welding accessory 36 may communicate with the welding system 10. Additionally, the welding accessory 36 is a device that may be used at a welding application remote from an associated welding power supply unit 12 and/or welding wire feeder 14, yet still communicates with the remote welding power supply unit 12 and/or welding wire feeder 14. In other words, the welding accessory 36 may receive data and relay the data back to the welding power supply unit 12 and/or the welding wire feeder 14 (e.g., via a wireless network connection).

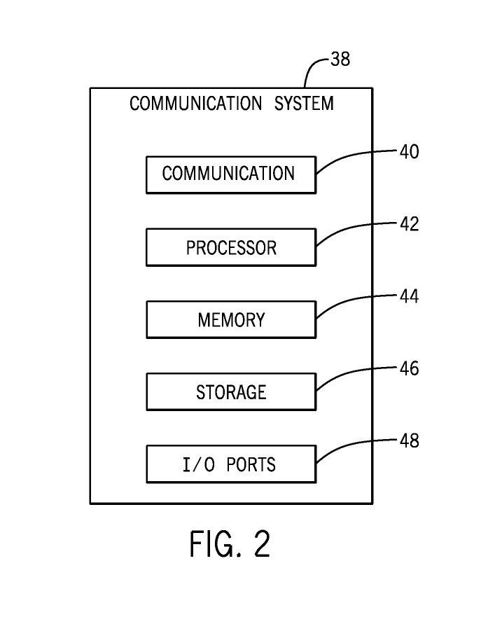

In certain embodiments, the power supply unit 12 may include a communication system 38. The communication system 38 may be a programmable logic controller (PLC) or a computing device that receives data from various welding components (e.g., wire feeder 14) via any wired or wireless medium and transmits the received data over power lines coupled to the AC power source 30. For instance, the communication system 38 may receive data from various components via wireless devices such as IEEE 802.15.1 Bluetooth®, IEEE 802.15.4 with or without a ZigBee® stack, IEEE 802.11x Wi-Fi, wired communications service such as IEEE 802.3 Ethernet, RS-232, RS-485, or any of the telecommunication MODEM standards such as V.32 etc. After receiving this data, the communication system 38 may modify the received data such that it may be transmitted over the power lines coupled to the AC power source 30. Additional details regarding this transmission of data will be provided below with reference to FIGS. 2-5.

The communication system 38 may include certain components to enable it to send and receive data via power lines. For example, as shown in FIG. 2, the communication system 38 may include a communication component 40, a processor 42, a memory 44, a storage 46, input/output (I/O) ports 48, and the like. The communication component 40 may be a wireless or wired communication component that may facilitate communication between various components and other welding systems via the power lines. That is, the communication component 40 may receive data from various welding components via a wired or wireless network and may transmit the received data via the power lines.

The processor 42 or multiple processors of the communication system 38 may be capable of executing computer-executable code. The memory 44 and the storage 46 may be any suitable articles of manufacture that can serve as media to store processor-executable code, data, or the like. These articles of manufacture may represent computer-readable media (i.e., any suitable form of memory or storage) that may store the processor-executable code used by the processor. The memory 44 and the storage 46 may also be used to store data, analysis of data, and the like. The memory 44 and the storage 46 may represent non-transitory computer-readable media (i.e., any suitable form of memory or storage) that may store the processor-executable code used by the processor 42. It should be noted that non-transitory merely indicates that the media is tangible and not merely a signal. The I/O ports 48 may be interfaces that may couple to different types of I/O modules.

In certain embodiments, the communication system 38 may be part of a stand-alone device or a device that is separate from the welding power supply unit 12. In this way, the stand-alone device may receive power from the AC power source 30 and may receive data from the welding power supply unit 12 or any other welding component. After receiving the data, the stand-alone device may transmit the data via the AC power line in which it receives power from the AC power source 30 using the techniques described herein. Additionally, the stand-alone device may send the data to a remote computer via wired networks (e.g., Ethernet, telephone modem, etc.) or wirelessly using any radio device connected through a network to reach the desired computer.

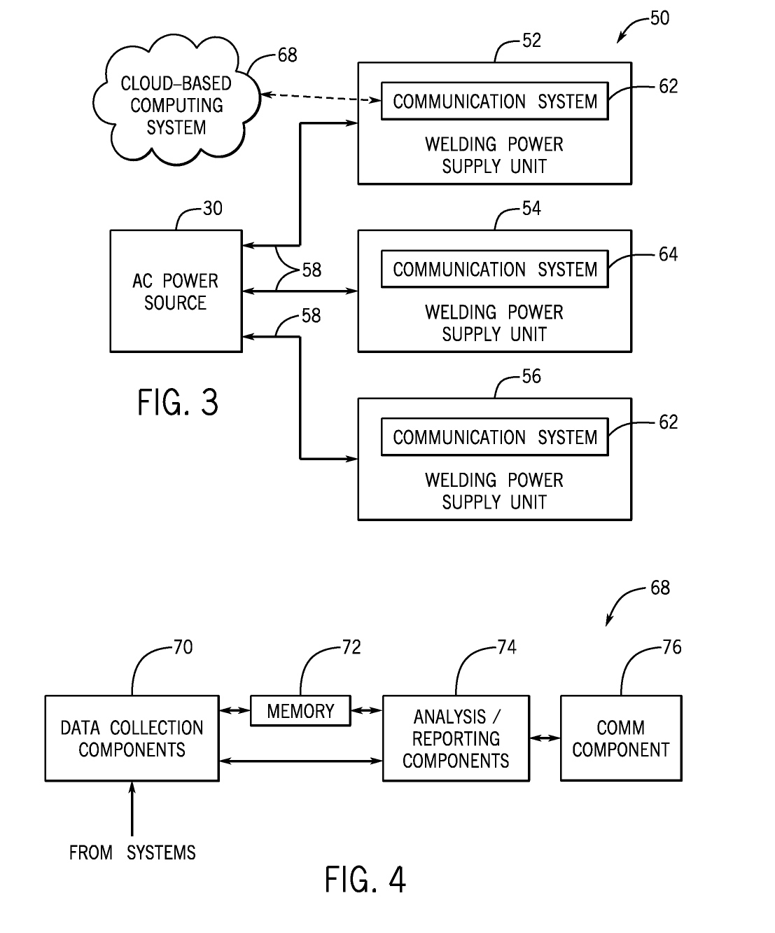

Keeping the foregoing in mind, FIG. 3 illustrates a network 50 that may be formed between multiples welding systems, such as the welding system 10 of FIG. 1. The network 50 may facilitate communication of data between, for example, three welding power supply units: a first welding power supply unit 52, a second welding power supply unit 54, and a third welding power supply unit 56. It should be noted, however, that the network 50 may include any number of welding power supply units.

In certain embodiments, each welding power supply unit 52, 54, 56 may receive AC power from the AC power source 30 via AC power lines 58. In addition to receiving power from the AC power lines 58, each welding power supply unit 52, 54, 56 may communicate with each other using the AC power lines 58. To facilitate this communication, each welding power supply unit 52, 54, and 56 may include a communication system, as described above. For instance, as shown in FIG. 3, the welding power supply units 52, 54, 56 may employ communication systems 62, 64, 66 to transmit data via the AC power lines 58. In this manner, the welding power supply units 52, 54, 56 may communicate or transmit data between each other.

In addition to communicating with other welding systems, at least one of the welding power supply units 52, 54, 56 (e.g., the first welding system 52 in the illustrated embodiment) may be communicatively coupled to a cloud-based computing system 68 via the communication system 62. The cloud-based computing system 68 may be a network of computing devices that may provide data storage and analysis services.

FIG. 4 illustrates functional components that may be used to provide the storage and analysis services by the cloud-based computing system 68. As shown in FIG. 4, the cloud-based computing system 68 may include, for example, data collection components 70 that receive data regarding the welding power supply units 52, 54, 56 and other entities via the communication system 62. The data collection components 70 may “pull” the data by prompting data exchange with the communication system 62, or may work on a “push” basis where data is provided to the data collection components 70 by the communication system 62 without prompting. The data collection may occur at any desired frequency, or at points in time that are not cyclic. For example, data may be collected on a periodic basis as welding operations are performed, or data may be provided on a shift basis, a daily basis, a weekly basis, or as desired by a welding operator or facilities management team.

The cloud-based computing system 68 may also include memory 72 that store raw and processed data collected from the systems. Analysis/reporting components 74 may provide processing services for the raw data, and associating the resulting analysis with systems, entities, groups, welding operators, and so forth. Additionally, communications components 76 may allow for populating reports and interface pages with the results of the analysis. In certain embodiments, the communications components 76 may include various servers, modems, Internet interfaces, webpage definitions, and the like.

By transmitting the data associated with the welding power supply units 52, 54, 56 to the cloud-computing system 68, a wide range of data regarding the welding power supply units 52, 54, 56 and support equipment may be available for storage, analysis, tracking, monitoring, comparison and so forth. Moreover, the cloud-based computing system 68 may be available to remote users, via the Internet or some other network connection, to enable the users to view the data or analysis as webpages that can be provided to and view on a general-purpose browser. In practice, however, any suitable interface may be used. The use of general practice browsers and similar interfaces, however, allows for the data to be served to any range of device platforms and different types of devices, including stationary workstations, enterprise systems, but also mobile and handheld devices.

With the foregoing in mind and referring back to FIG. 3, the communication systems 62, 64, 66 may communicate via the AC power lines 58 using IEEE 1139 Broadband Over Power Line technology (BPL), IEEE 1901.2 G3 Power Line Communications (PLC), or the like. That is, the communication systems 62, 64, 66 may convert data received from various components into data that may be transmitted via the power lines 58. In certain embodiments, the data received from various components may be digital data. As such, prior to transmitting the digital data via the power lines 58, the communication system 64, for example, may convert the digital data to analog data using a digital-to-analog converter. The resulting analog data may then be transmitted to the power lines 58 and may be received by another communication system (e.g. communication system 62). Although the communication systems 62, 64, 66 are described with reference to FIG. 3 as communicating between each other in a certain manner, it should be noted that each of the communication systems 62, 64, 66 may perform similar functions as described herein.

Upon receiving the analog data, the communication system 62 may convert the analog data into digital data using an analog-to-digital converter. The communication system 62 may also convert the digital data into data that may be interpretable by web devices or the cloud-based computing system 68 before transmitting the data to a network. In certain embodiments, the welding system 52 may receive data from the other welding systems 54, 56 via the AC power lines 58. After receiving the data, the communication system 62 of the welding system 52 may transmit the received data to the cloud-based computing system 68.

In addition to converting data to analog or digital formats, the communication systems 62, 64, 66 may modulate and/or demodulate the received data, such that the data may be communicated via the power lines 58. In certain embodiments, the communication system 62, for example, may modulate or encode the data being transmitted using a Orthogonal Frequency Division Multiplex (OFDM) scheme or a Code division multiple access (CDMA) scheme along with a multiplicity of symbol encoding schemes such as Differential Bi-Phase (DBPSK), Coherent Bi-Phase (BPSK), Differential Quadrature Phase (DQPSK), Offset Quadrature Phase (O-QPSK), Differential 8 Phase Shift Keying (D8PSK), 8 Phase Shift Keying (8-PSK), 8 Quadrature Amplitude Modulation (8-QAM), 16-Quadrature Amplitude Keying (16-QAM), any m-ary phase shift key modulation method whether differential or coherent, any m-ary Quadrature Amplitude modulation method, and the like. By using the above-referenced schemes, the communication systems 62, 64, 66 may transmit and receive digital data between various components of various welding systems connected to a common AC power source (e.g., AC power source 30) via AC power lines 58.

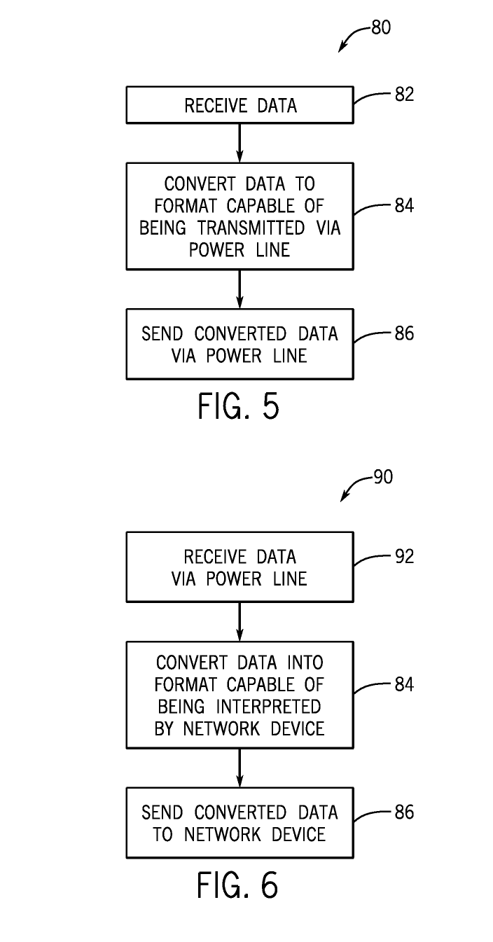

Keeping the foregoing in mind, FIG. 5 illustrates a method 80 that may be employed by the communication system 64 to transmit data via the power lines 58. Although the method 80 is described herein as being performed by the communication system 64, it should be understood that any other communication system 62 or 66 may be capable of performing the same method. At block 82, the communication system 64 may receive data from various welding components in its respective welding power supply unit (e.g., welding power supply unit 54 in this example). The communication system 64 may receive data via any wired or wireless means.

After receiving the data, the communication system 64 may, at block 84, convert the data into a format that may be suited for transmitting over the power lines 58. In certain embodiments, the received data may be in a digital format. As such, the communication system 64 may convert the received data into an analog format as mentioned above. After converting the data into an analog format, the communication system 64 may modulate the analog data such that it may be transmitted over the AC power lines 58. The communication system 64 may modulate the analog data using any of the described modulation schemes discussed above.

At block 86, the communication system 64 may send or transmit the modulated analog data over the AC power lines 58. In certain embodiments, the communication system 64 may transmit the data over the power lines 58 using a transformer coupled to the AC power lines 58. As such, the communication system 64 may transmit the data via the power lines 58 using a current mode coupler (i.e., current transformer coupled to the power lines 58) or a voltage mode coupler (i.e., voltage transformer coupled to the power lines 58). If the AC power source 30 is a multi-phase power source, the communication system 38 may transmit the data to the AC power source 30 via a shunt coupled across two phases of the multi-phase power source or via a shunt coupled across one phase of the multi-phase power source and a neutral or ground connection.

As shown in FIG. 2, in certain embodiments, a limited number of welding systems in the network 50 may have a network connection to the cloud-based computing system 68. As such, the communication system 62 may aggregate data received from various communication systems (e.g., communication systems 64, 66 in the illustrated embodiment) via the AC power lines 58 and transmit the aggregated data to the cloud-based computing system 68. In this way, although each welding power supply unit 52, 54, 56 may not have a network connection to the cloud-based computing system 68, each welding power supply unit 52, 54, 56 may communicate with the cloud-based computing system 68 via the AC power lines 58 and the communication system (e.g., communication system 62 in the illustrated embodiment) that does have a direct link to the cloud-based computing system 68.

With this in mind, FIG. 6 illustrates a method 90 that the communication system 62 may employ when transmitting data to the cloud-based computing system 68. Again, although the method 90 is described herein as being performed by the communication system 62, it should be understood that any other communication system 64 or 66 may be capable of performing the same method. At block 92, the communication system 62 may receive data via the AC power line 58. Similar to transmitting data via the AC power line 58, the communication system 62 may receive the data via a transformer or the like.

At block 94, the communication system 62 may convert the received data into a format that may be interpretable by a network device, such as the cloud-based computing system 68. As such, the communication system 62 may demodulate the received analog signal and then convert the demodulated analog signal into a digital signal.

At block 96, the communication system 62 may transmit the converted data to the network device via a wired or wireless connection. In certain embodiments, the communication system 62 may include or be communicatively coupled to a modem that may establish a network connection to the network device, such as the cloud-based computing system 68.

By enabling welding systems to communicate data between each other over AC power lines, each welding system may be part of a local network of components. In certain environments where welding systems are typically employed, establishing communication links between various welding systems may be difficult. By creating a local network using AC power lines as described herein, the welding systems are capable of communicating with each other without using additional communication links or wired connections. Moreover, since each of the welding systems may be connected to each other locally, the data of each welding system may be routed to any particular welding system or a particular component in a welding system, which may then transmit the data outside the local network. In this way, data related to various welding systems may be made accessible remotely without providing a network connection to each welding system.

While only certain features of the disclosure have been illustrated and described herein, many modifications and changes will occur to those skilled in the art. It is, therefore, to be understood that the appended claims are intended to cover all such modifications and changes as fall within the true spirit of the embodiments presented in this disclosure.

1. A welding power supply unit comprising:
a communication circuit configured to:
receive a first set of data via a power cable configured to provide power to the welding power supply unit for use in a welding operation;
convert the first set of data into a second set of data configured to be interpretable by a network device; and
send the second set of data to the network device.

2. The welding power supply unit of claim 1, wherein the communication circuit is configured to convert the first set of data into the second set of data by:
demodulating the first set of data to generate a demodulated set of data; and
converting the demodulated signal into a digital set of data.

3. The welding power supply unit of claim 1, wherein the first set of data comprises analog data.

4. The welding power supply unit of claim 1, wherein the first set of data comprises encoded data.

5. The welding power supply unit of claim 4, wherein the encoded data is encoded using an Orthogonal Frequency Division Multiplex (OFDM) scheme or a Code division multiple access (CDMA) scheme along with at least one symbol encoding scheme.

6. The welding power supply unit of claim 5, wherein the at least one symbol encoding scheme comprises a Differential Bi-Phase (DBPSK) scheme, a Coherent Bi-Phase (BPSK) scheme, a Differential Quadrature Phase (DQPSK) scheme, an Offset Quadrature Phase (O-QPSK) scheme, a Differential 8 Phase Shift Keying (D8PSK) scheme, an 8 Phase Shift Keying (8-PSK) scheme, an 8 Quadrature Amplitude Modulation (8-QAM) scheme, a 16-Quadrature Amplitude Keying (16-QAM) scheme, or any combination thereof.

7. The welding power supply unit of claim 1, wherein the network device comprises a cloud-based computing system.

8. The welding power supply unit of claim 7, wherein the cloud-based computing system is configured to analyze the second set of data.

9. The welding power supply unit of claim 1, comprising a modem configured to communicatively couple to the network device.

10. The welding power supply unit of claim 1, wherein the second set of data is sent to the network device via a wired or wireless connection.

11. A welding system, comprising:
one or more power cables configured to provide an alternating current (AC) power from a source of power to a plurality of welding power supply units;
a first welding power supply unit of the plurality of welding power supply units configured to receive the AC power via one of the power cables, wherein the first welding power supply unit comprises a first communication component configured to couple to the one of the power cables, and wherein the first communication component is configured to send a first set of data via the one of the power cables; and
a second welding power supply unit is configured to receive the AC power via the one of the power cables, wherein the second welding power supply unit comprises a second communication component configured to couple to the one of the power cables, wherein the second communication component is configured to receive the first set of data via the one of the power cables.

12. The welding system of claim 11, wherein the first communication component is configured to:
receive the first set of data from the first welding power supply unit;
convert the first of set of data into a third set of data configured to be transmitted via the one of the power cables; and
transmit the third set of data via the one of the power cables.

13. The welding system of claim 12, comprising a transformer configured to couple to the one of the power cables and the first communication component, wherein the second set of data is transmitted via the one of the power cables using the transformer.

14. The welding system of claim 13, wherein the transformer is a current mode transformer or a voltage mode transformer.

15. The welding system of claim 11, comprising a cloud-based computing system, wherein the second communication component is configured to send the second set of data to the cloud-based computing system.

16. The welding system of claim 15, wherein the second communication component is configured to send the second set of data to the cloud-based computing system via a wired or a wireless communication medium.

17. The welding system of claim 11, wherein the source of power comprises a multi-phase source of power.

18. A device configured to communicate data via an alternating current (AC) power line, comprising:
a processor configured to:
receive a first set of data from a welding power supply unit configured to perform a welding operation;
convert the first set of data to a second set of data configured to be transmitted via the power line configured to provide power to the welding supply unit;
send the second set of data to a communication circuit of a second welding power supply unit via the power line or to a network device.

19. The device of claim 18, wherein the first set of data comprise digital data.

20. The device of claim 18, the processor is configured to convert the first set of data to the second set of data by:
converting the digital data to analog data; and
encoding the analog data.

21. The device of claim 19, wherein the analog data is encoded based on an Orthogonal Frequency Division Multiplex (OFDM) scheme, a Code division multiple access (CDMA) scheme, a Differential Bi-Phase (DBPSK) scheme, a Coherent Bi-Phase (BPSK) scheme, a Differential Quadrature Phase (DQPSK) scheme, an Offset Quadrature Phase (O-QPSK) scheme, a Differential 8 Phase Shift Keying (D8PSK) scheme, an 8 Phase Shift Keying (8-PSK) scheme, an 8 Quadrature Amplitude Modulation (8-QAM) scheme, a 16-Quadrature Amplitude Keying (16-QAM) scheme, or any combination thereof.
